(19) United States
(12) Patent Application Publication
(10) Pub. No.: US 2011/0029493 A1
(43) Pub. Date: Feb. 3, 2011

(54) Generic Method To Build Catalogs For Change Management

(76) Inventors: Jianwen Yin, Round Rock, TX (US); James Watt, Pflugerville, TX (US)

Correspondence Address: HAMILTON & TERRILE, LLP, P.O. BOX 203518, AUSTIN, TX, 78720, US

(21) Appl. No.: 12/510,359

(22) Filed: Jul. 28, 2009

(51) Int. Cl. G06F 7/00

(52) U.S. Cl. 707/694; 707/E17.044

(57) ABSTRACT

A generic catalog build process which takes information and combines and displays the information in a number of ways, such that the process allows incorporation of a plurality of different builds in an organized and extensible way. Such a generic catalog build process advantageously lowers maintenance cost and development cost of for generating catalogs.

### BACKGROUND OF THE INVENTION

1. Field of the Invention

The present invention relates to information handling systems and more particularly to a method to build catalogs for change management within a facility for fabricating information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue relating to information handling systems is how best to deploy update packages (i.e., packages of software updates) to deployed information handling systems. It is known to use catalogs (i.e., listings of update packages which are used by update tools) to deploy updates to information handling system customers, especially customers having large installed bases of information handling systems. The catalogs include information about the updates such as the file names, locations, urgency, applicable platforms, and release dates. Catalogs can also provide groupings of update packages that are recommend for deploying together as a tested configuration of a system.

Often it falls upon a change management group within an information handling system manufacturer to support a number of build processes that produce catalogs for partners and customers to use to update their systems. With the growing needs of supporting more and more partners and customers, maintaining the processes around building catalogs can be a nearly impossible task. The number of permutations of different build processes can cause a prohibitive cost in maintaining active build processes while trying to develop and incorporate new build processes.

For example, in one example, a change management group maintains two separate build processes: a partner developer kit (PDK) and a software distribution package (SDP) build processes. Additionally, this same change management group may further support a third build process for urgent updates (e.g., a Hotfix process).

Accordingly, it would be desirable to provide a method for producing catalogs in real time as well as for producing any desired catalog data set based upon certain search criteria.

### SUMMARY OF THE INVENTION

In accordance with the present invention, a generic catalog build process is set forth which takes information and combines and displays the information in a number of ways, such that the process allows incorporation of a plurality of different builds in an organized and extensible way. Such a build process advantageously lowers maintenance cost and development cost of for generating catalogs.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a block diagram of a generic catalog build system.

FIG. 3 shows an example data flow of a generic catalog build process.

### DETAILED DESCRIPTION

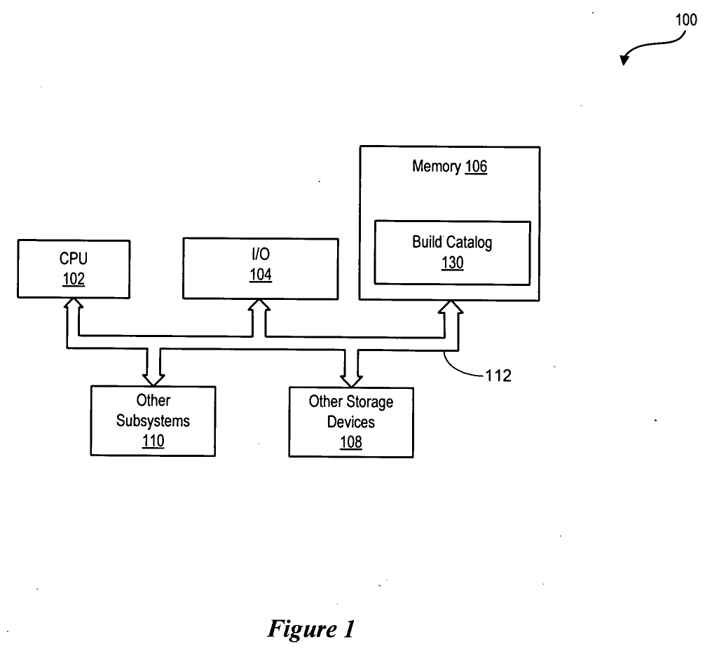

Referring briefly to FIG. 1, a system block diagram of an information handling system 100 is shown. The information handling system 100 includes a processor 102, input/output (I/O) devices 104, such as a display, a keyboard, a mouse, and associated controllers (each of which may be coupled remotely to the information handling system 100), a memory 106 including volatile memory such as random access memory (RAM) and non-volatile memory such as a hard disk and drive, and other storage devices 108, such as an optical disk and drive and other memory devices, and various other subsystems 110, all interconnected via one or more buses 112.

The information handling system further includes a generic catalog build system 130 stored on the memory for execution by the processor. The catalog build system 130 provides a generic catalog build process which takes information and combines and displays the information in a number of ways, such that the process allows incorporation of a plurality of different builds in an organized and extensible way. Such a build process advantageously lowers maintenance cost and development cost of for generating catalogs.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

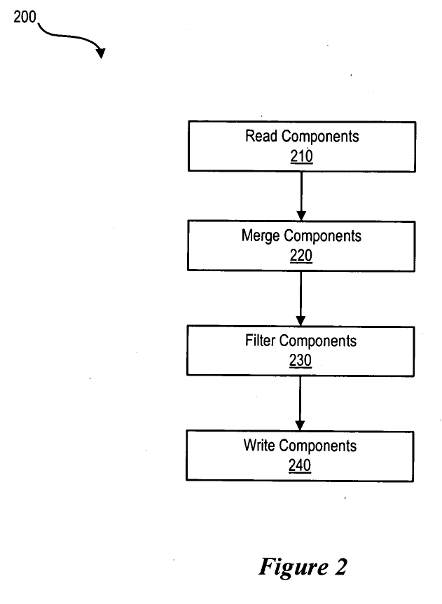

Referring to FIG. 2, a block diagram of a generic catalog build system 130 is shown. More specifically, the generic catalog build system 130 includes a reader component portion 210, a merge component portion 220, a filter component portion 230 and a write component portion 240.

The reader component portion 210 includes a plurality of reader components which collect data samples, often small data samples of less than a couple of Kbytes up to around 500 Mbytes in size. For example, a reader component may be designed to retrieve the names of all the update package (UP) files from an internal software life cycle data storage device and the release identifiers (IDs) attached to each update file. In another example, the reader component may include a component to retrieve a list of all the vendor versions attached to particular update files.

The merge component portion 220 includes a plurality of merge components that merge data with other sets of data. The merge components can perform operations similar to database join operations and also perform an append operation. The merge components merge together and append results from the reader components.

The filter component portion 230 includes a plurality of filter Components that produce a new data set given a set of rules and an input piece of data. For example, one specific filter may filter all release IDs that are less than 10000 from a set of data that has release IDs. Another filter may remove rows that don't have DUP style file names from a data set that contains file names.

The write component portion 240 includes a plurality of write Components that represent data in a certain fashion, i.e. a certain catalog format. Examples of catalog formats include the PDK format and the SDP 3.0 and SDP 3.1 formats for Microsoft.

By providing various combinations of the components within a catalog build system, the catalog build system can produce substantially all desired change management catalogs. Additionally, providing the generic catalog build system with the component portions allows other catalogs to reuse the same Read/Filter/Merge components as needed. Such a system reduces duplicated work between the build processes and lowers maintenance cost. Such a system also allows new catalogs to be efficiently generated by leveraging common components from previous catalogs.

By using the generic build system 130, it is possible to create a catalog in which urgent updates are frequently posted. For example, in one permutation of using the generic catalog build system 130, a “hotfix” catalog can be easily generated which uses reader components from a quarterly PDK build, but add a filter that selects only “urgent” releases.

Additionally, client products that wish to leverage enterprise catalog technologies, can use the generic catalog build system to make use of enterprise write components so catalogs of the client are in formats accepted by partners, while generating client specific read components to enable the content of their catalog to be client specific.

Additionally, the generic build system 130 can allow customers to create custom catalogs in real time based on current update information of a manufacturer. The generic build system 130 allows customers to create substantially all possible permutations of an update catalog, by for example selecting or searching for platform, urgency, update category, or other qualifier and output that catalog in their selected format (PDK, SDP 3.0, SDP 3.1)

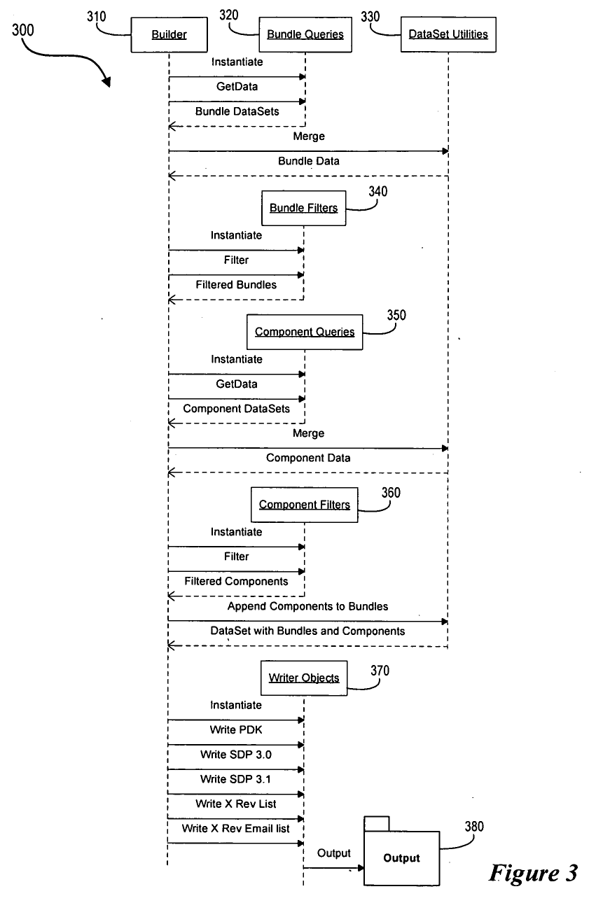

Referring to FIG. 3, an example data flow of a generic catalog build process 300 is shown. More specifically, operation of the catalog build process starts when a builder object 310 is instantiated and performs a GetData operation with a Bundle Queries object 320. Next the Bundle Queries object 320 bundles data sets according to the Get Data operation and provides the bundled data sets to the Builder object. Next the Builder object calls a DataSet Utilities Object 330 to perform a merge operation. Next, the DataSet Utilities Object 330 provides Bundled data to the builder object.

Next the Builder Object instantiates a Bundle Filters object 340 to perform a filter operation. The Bundle Filters object 340 provides Filtered Bundles to the Builder Object 310. Next, the Builder Object instantiates a Component Queries object 350 which performs a GetData operation. The Component Queries object provides a Component DataSets to the Builder Object 310. The Builder Object then performs a merge operation via the DataSet Utilities object, 330 which provides component data to the Builder object 310.

Next, the Builder Object 310 instantiates a Component Filters object 360 to perform a filter operation. The Component Filters object 360 provides Filtered components to the Builder Object 310. Next the Builder object calls the DataSet Utilities Object 330 to perform an appent components to bundles operation. Next, the DataSet Utilities Object 330 provides a DataSet with Bundles and Components.

Next, the Builder Object 310 instantiates Writer Objects 370. The Builder Object 310 requests a plurality of write operations from the Writer Objects 370. For example, the Builder Object 310 requests a Write PDK write operation, a Write SDP 3.0 write operation, a Write SDP 3.1 write operation, a Write X Rev List write operation and a Write X Rev Email list write operation.

Next, the Write Objects 370 generate an output 380 based upon the plurality of write operations.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any information handling system including, but not limited to, personal computers, servers, workstations, network computers, main frame computers, routers, switches, Personal Digital Assistants (PDA's), telephones, and any other system capable of processing, transmitting, receiving, capturing and/or storing data.

It should be understood that at least some aspects of the present invention may alternatively be implemented in a computer readable medium that contains a program product. Programs defining functions on the present invention can be delivered to a data storage system or a computer system via a variety of media, which include, without limitation, non-writable storage media (e.g., CD-ROM), writable storage media (e.g., hard disk drive, read/write CD ROM, optical media), system memory such as but not limited to Random Access Memory (RAM). Further, it should be understood that the present invention may be implemented by a system having means in the form of hardware, software, or a combination of software and hardware as described herein or their equivalent.

Also for example, the above-discussed embodiments include software modules that perform certain tasks. The software modules discussed herein may include script, batch, or other executable files. The software modules may be stored on a machine-readable or computer-readable storage medium. Storage devices used for storing software modules in accordance with an embodiment of the invention may be any type of non-volatile memory including hard disks optical discs such as CD-ROMs or CD-Rs, or flash memory. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. An information handling system implemented method for building a catalog of comprising:
collecting a plurality of data samples for inclusion within the catalog via an information handling system;
merging the data samples via the information handling system;
filtering the data samples to provide a data set based upon a set of rules via the information handling system; and,
representing the data set in a predefined catalog format via the information handling system.

2. The method of claim 1 wherein:
the catalog includes information for deploying update packages to information handling systems.

3. The method of claim 2 wherein:
the catalogs comprise information about the update packages comprising file names, locations, urgency, applicable platforms, and release dates.

4. The method of claim 3 wherein:
the catalogs comprise groupings of update packages that are recommend for deploying together as a tested configuration of an information handling system.

5. The method of claim 1 wherein:
the catalogs deploy updates to information handling system customers having large installed bases of information handling systems.

6. A system comprising:
a processor;
a bus coupled to the processor; and
a computer readable medium embodying program code, the computer readable medium being coupled to the bus, the program code comprising instructions for building a catalog executable by the processor and configured for:
collecting a plurality of data samples for inclusion within the catalog;
merging the data samples;
filtering the data samples to provide a data set based upon a set of rules; and,
representing the data set in a predefined catalog format.

7. The method of claim 6 wherein:
the catalog includes information for deploying update packages to information handling systems.

8. The method of claim 7 wherein:
the catalogs comprise information about the update packages comprising file names, locations, urgency, applicable platforms, and release dates.

9. The method of claim 8 wherein:
the catalogs comprise groupings of update packages that are recommend for deploying together as a tested configuration of an information handling system.

10. The method of claim 6 wherein:
the catalogs deploy updates to information handling system customers having large installed bases of information handling systems.

11. A computer readable medium embodying program code, the program code comprising instructions configured for:
collecting a plurality of data samples for inclusion within the catalog via an information handling system;
merging the data samples via the information handling system;
filtering the data samples to provide a data set based upon a set of rules via the information handling system; and,
representing the data set in a predefined catalog format via the information handling system.

12. The computer readable medium of claim 11, wherein:
the catalog includes information for deploying update packages to information handling systems.

13. The computer readable medium of claim 12, wherein:
the catalogs comprise information about the update packages comprising file names, locations, urgency, applicable platforms, and release dates.

14. The computer readable medium of claim 13, wherein:
the catalogs comprise groupings of update packages that are recommend for deploying together as a tested configuration of an information handling system.

15. The computer readable medium of claim 13, wherein:
the catalogs deploy updates to information handling system customers having large installed bases of information handling systems.
